(19) United States
(12) Patent Application Publication
(10) Pub. No.: US 2011/0062645 A1
(43) Pub. Date: Mar. 17, 2011

(54) SHEET FINISHING APPARATUS AND SHEET FINISHING METHOD

(75) Inventor: Hidetoshi YOKOCHI, Shizuoka-Ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/860,400

(22) Filed: Aug. 20, 2010

Related U.S. Application Data
(60) Provisional application No. 61/242,715, filed on Sep. 15, 2009.

(51) Int. Cl. B42C 99/00

(52) U.S. Cl. 270/45

(57) ABSTRACT

The sheet finishing apparatus according to the embodiment includes a main body configured to fold a bundle of sheets to form a booklet, a base plate extending obliquely downward from a side wall of the main body to allow loading of a plurality of the booklets discharged in sequence from a discharging port provided in the side wall, a discharging roller pair configured to push the booklet out from the discharging port to discharge the booklet on the base plate, and a projecting member configured to project from the side wall substantially horizontally and support the lower portion of the booklet between the discharging port and the base plate when the discharging roller pair pushes the booklet out.

### CROSS-REFERENCE TO RELATED APPLICATIONS

This application is based upon and claims the benefit of priority from: U.S. provisional applications 61/242,715 filed on Sep. 15, 2009, the entire contents of which are incorporated herein by reference.

### FIELD

Embodiments described herein relate generally to a sheet finishing apparatus and sheet finishing method.

### BACKGROUND

In the related art, as a sheet finishing apparatus installed on the downstream side of an image forming apparatus such as a copying machine, a printer, or a MFP (Multi-Functional Peripheral) and configured to bind booklets by performing a finishing process such as folding or stapling on printed sheets is known.

Many of the sheet finishing apparatuses of these type include a sheet placing unit (loading tray) for loading a plurality of the bound booklets.

The booklets themselves are bound in a finishing apparatus body, and the booklets discharged from a discharging port of the finishing apparatus body one after another are loaded on the sheet placing unit in sequence.

A bundle of the booklets to be loaded on the sheet placing unit does not necessarily have a uniform thickness, and a leading end portion (a portion where a fold line is formed) is thicker, and thus a center portion is depressed in many cases. Consequently, a leading end of the booklet discharged subsequently may hit against the depression or the depression of the booklet pushes back the leading end of the booklet, so that smooth discharge may be hindered. Accordingly, improvement of a mechanism is required to achieve smooth discharge of the subsequent booklets even if the thickness of the bundle of booklets loaded on the sheet placing unit is not uniform.

### BRIEF DESCRIPTION OF THE DRAWINGS

FIG. 1 is a perspective view showing an example of an appearance of an image forming apparatus provided with a sheet finishing apparatus in an embodiment;

FIG. 2 is a cross-sectional view showing an example of a configuration of the image forming apparatus;

FIG. 3 is a cross-sectional view showing an example of a configuration of the sheet finishing apparatus;

FIG. 4 is a perspective appearance view showing an example of a configuration of a sheet placing unit;

FIG. 5 is a perspective outline view of the sheet placing unit with an upper arm and a fore arm removed;

FIG. 6 is a diagrammatic drawing of the sheet placing unit and part of the sheet finishing apparatus body viewed from the front of the image forming apparatus;

FIGS. 7A and 7B are drawings showing discharging and loading situations of booklets in a sheet finishing apparatus in the related art as comparative examples;

FIGS. 8A and 8B are first drawings showing discharging and loading situations of booklets in the sheet finishing apparatus according to the embodiment;

FIGS. 9A and 9B are second drawings showing discharging and loading situations of booklets in the sheet finishing apparatus according to the embodiment; and

FIG. 10 is a drawing showing another example of a projecting member.

### DETAILED DESCRIPTION

Referring now to the attached drawings, an embodiment of a sheet finishing apparatus and a sheet finishing method will be described.

The sheet finishing apparatus according to the embodiment includes a main body configured to fold a bundle of sheets to form a booklet, a base plate extending obliquely downward from a side wall of the main body to allow loading of a plurality of the booklets discharged in sequence from a discharging port provided in the side wall, a discharging roller pair configured to push the booklet out from the discharging port to discharge the booklet on the base plate, and a projecting member configured to project from the side wall substantially horizontally and support the lower portion of the booklet between the discharging port and the base plate when the discharging roller pair pushes the booklet out.

### (1) Configuration

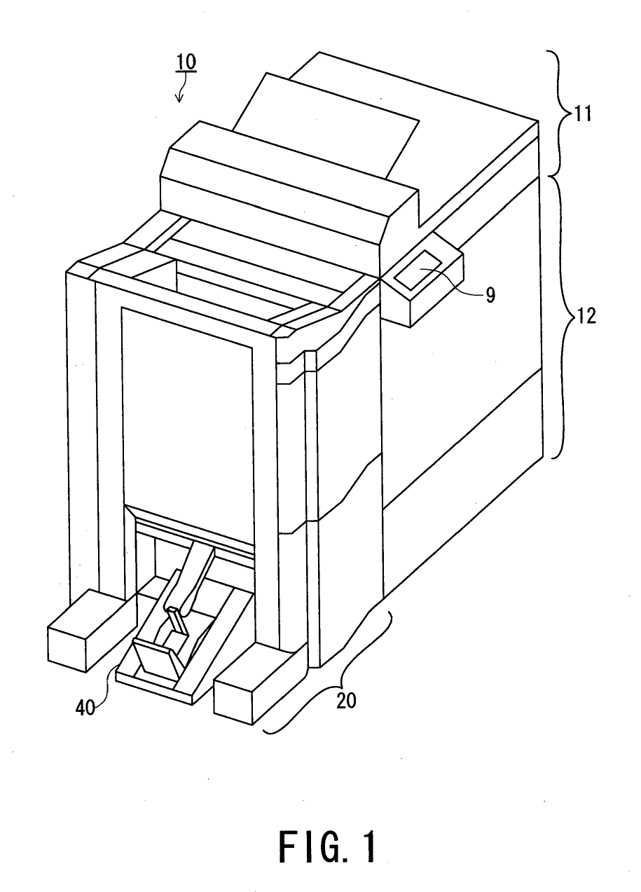

FIG. 1 is a perspective view showing an appearance of an example of a basic configuration of an image forming apparatus 10 having a sheet finishing apparatus 20 according to a first embodiment. The image forming apparatus 10 includes a scanning unit 11 configured to scan documents, an image forming unit 12 configured to print image data of the scanned documents on a sheet on the basis of an electrophotographic system, and the sheet finishing apparatus 20 configured to perform a finishing process such as sorting, punching, folding, and saddle-stitching for the printed sheets. The image forming unit 12 also includes an operating unit 9 through which users perform various operations.

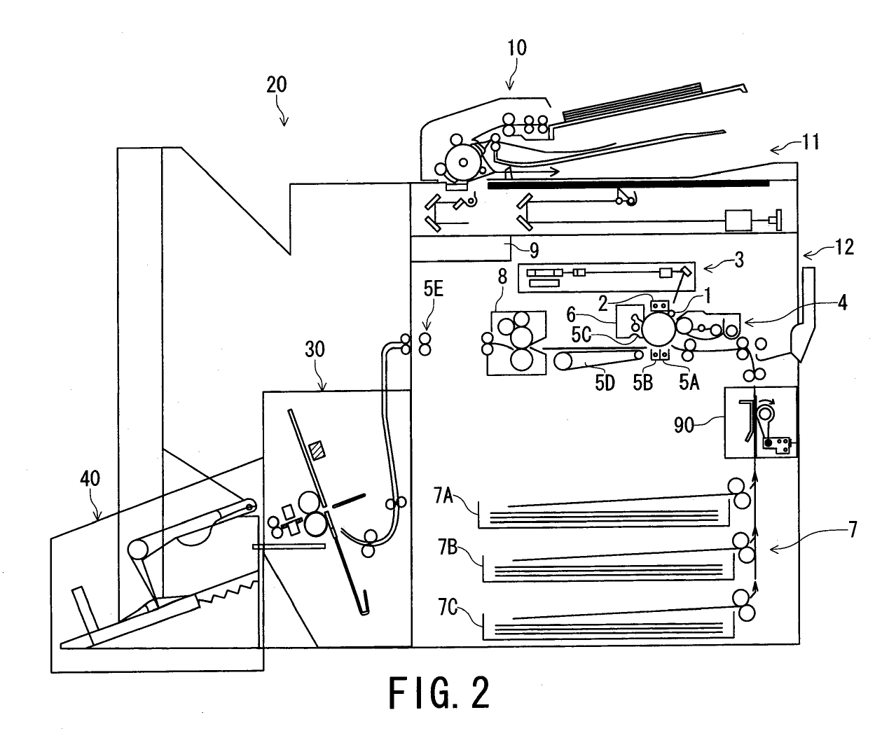

FIG. 2 is a cross-sectional view showing an example of a detailed configuration of the image forming apparatus 10.

The image forming unit 12 of the image forming apparatus 10 includes a photoconductive drum 1 at a center thereof, and also includes a charging unit 2, an exposure unit 3, a developing unit 4, a transfer unit 5A, a charge removing unit 5B, a separating claw 5C, and a cleaning unit 6 disposed respectively around the photoconductive drum 1. A fixing unit 8 is provided on the downstream side of the charge removing unit 5B. Image formation is performed by these members in a sequence schematically shown below.

First, the charging unit 2 charges the surface of the photoconductive drum 1 uniformly. In the meantime, the document scanned by the scanning unit 11 is converted into image data, which is input to the exposure unit 3. The exposure unit 3 irradiates the photoconductive drum 1 with laser beams according to the level of the image data to form an electrostatic latent image on the photosensitive drum 1. The electrostatic latent image is developed by toner supplied from the developing unit 4, whereby a toner image is formed on the photoconductive drum 1.

A sheet stored in a sheet storage unit 7 (7A, 7B, 7C) passes through a sheet thickness detector 90 via several carrying rollers and is carried to a transfer position (a clearance between the photoconductive drum 1 and the transfer unit 5A). At the transfer position, the transfer unit 5A transfers the toner image from the photoconductive drum 1 to the sheet. The charge removing unit 5B removes a charge on the surface of the sheet having the toner image transferred thereto. The separating claw 5C separates the sheet from the photoconductive drum 1. An intermediate carrying unit 5D carries the sheet, the fixing unit 8 heats and pressurizes, whereby the toner image is fixed to the sheet. The sheet after the fixation is discharged from the discharging unit 5E and output to the sheet finishing apparatus 20.

The cleaning unit 6 arranged on the downstream of the separating claw 5C removes developer remaining on the surface of the photoconductive drum 1 for being ready for the next image formation.

The sheet finishing apparatus 20 includes a paper folding device 30 and a sheet placing unit 40 in addition to a sorter unit that sorts the sheets.

The paper folding device 30 staples the center portions of the plurality of printed sheets discharged from the image forming unit 12, then folds and bookbinds the same (saddle-stitching) at the centers thereof to form a booklet. The saddle-stitching with a staple may be omitted. In this case, the sheets are simply folded in the middle and the folded bundles of sheets are loaded on the sheet placing unit 40.

The booklets saddle-stitched and center-folded (or simply center-folded) by the paper folding device 30 are output to the sheet placing unit 40, where the booklets (bundles of sheets) are finally placed on.

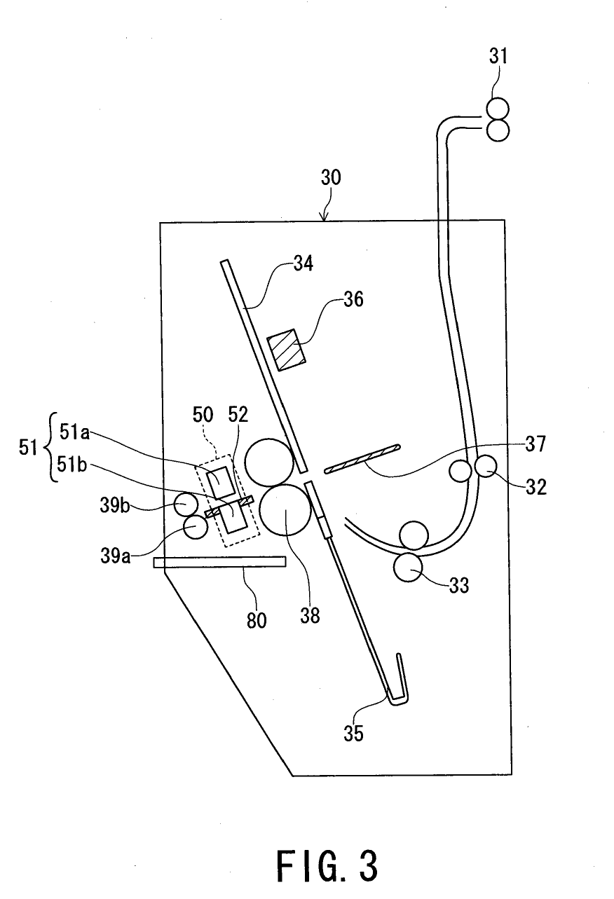

FIG. 3 is a cross-sectional view showing an example of a detailed configuration of the paper folding device 30.

The paper folding device 30 receives a sheet discharged from the discharging unit 5E of the image forming unit 12 by an inlet port roller pair 31, and feeds the same to an intermediate roller pair 32. The intermediate roller pair 32 in turn feeds the sheet to an outlet port roller pair 33. The outlet port roller pair 33 delivers the sheet to a standing tray 34 having an inclined placing surface. A leading edge of the sheet is directed upward of the inclination of the standing tray 34.

A stacker 35 waits below the standing tray 34 for receiving a lower end of the sheet being switched back and falling from upward of the inclination of the standing tray 34.

A stapler (saddle-stitching unit) 36 is disposed in a midsection of the standing tray 34. When saddle-stitching (stapling) the bundle of sheets, the position of the stacker 35 is adjusted so that a position of the bundle of sheets to be stapled (the center portion of the bundle of sheets in the vertical direction) opposes the stapler 36.

When the saddle-stitching of the bundle of sheets is finished by the stapler 36, the stacker 35 moves downward until the position of the bundle of sheets to be folded (stapled position at the center of the bundle of sheets in the vertical direction) comes to the front of a sheet-folding blade 37.

When the position to be folded comes to the front of the sheet-folding blade 37, a front end 37a of the sheet-folding blade 37 pushes the surface of the bundle of sheets, which is to be an inner surface when it is folded, inward.

A folding roller pair 38 is provided in front of the sheet-folding blade 37 in the direction of travel. The bundle of sheets pushed inward by the sheet-folding blade 37 is drawn into a nip of the folding roller pair 38, so that a fold line is formed at the center portion of the bundle of sheets. The sheet-folding blade 37 and the folding roller pair 38 constitute a sheet-folding unit.

The bundle of sheets on which the fold line is formed by the folding roller pair 38 is carried to a fold reinforcing unit 50 provided on the further downstream side thereof. The bundle of sheets carried to the fold reinforcing unit 50 stops temporarily on a placing bed 52.

The fold reinforcing unit 50 includes fold reinforcing rollers 51 (a pair of rollers including an upper roller 51a and a lower roller 51b). The fold reinforcing rollers 51 move while pressurizing the fold line in the direction orthogonal to the carrying direction of the bundle of sheets (the direction along the fold line) and reinforce the fold line.

The bundle of the sheets whose fold line is reinforced by the fold reinforcing unit 50 starts being carried again, is drawn into the nip of a discharging roller pair 39a and 39b, and is output to the sheet placing unit 40, where the saddled-stitched bundles of sheets, that is, booklets are placed on the sheet placing unit 40.

Note that a projecting member 80, which will be described later, is provided below the discharging roller pair 39a and 39b.

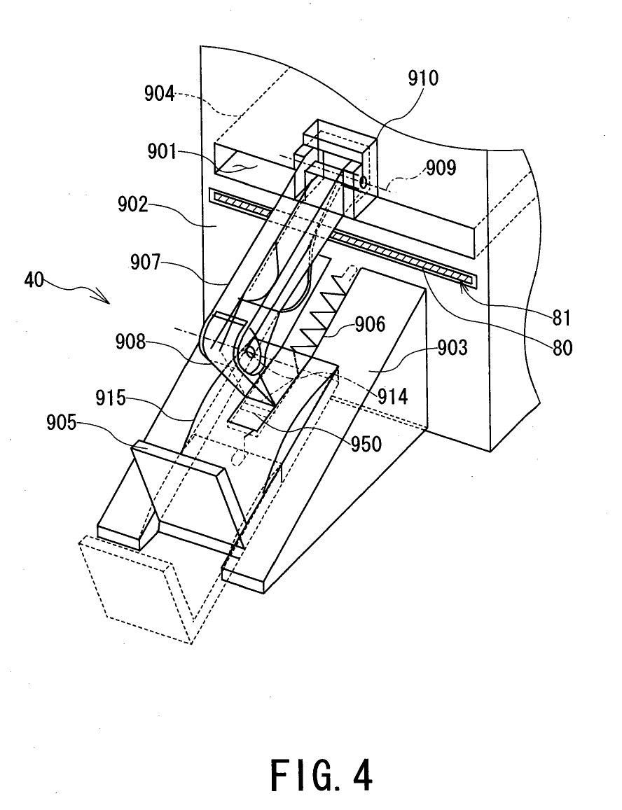

FIG. 4 is a drawing showing the sheet placing unit 40 of the sheet finishing apparatus 20 in an enlarged scale.

The sheet placing unit 40 includes a bed 903, a base plate 915, an upper arm 907, and a fore arm 908. A demountable guard 905 is provided at a front end of the base plate 915.

The base plate 915 is connected to an side wall 902 of the main body of the sheet finishing apparatus 20 via a spring 906, and extends obliquely downward from the side wall 902 of the main body together with the bed 903. The base plate 915 is a member for allowing the plurality of booklets discharged in sequence from the discharging port 901 provided in the side wall 902 to be loaded thereon.

A base end of the upper arm 907 is supported so as to be rotatable about a shaft 909 provided on a support 910, which is fixed to the side wall 902.

A shaft 914 is provided at a distal end of the upper arm 907, and an upper end of the fore arm 908 is rotatably supported by the shaft 914.

The base plate 915 forms a gentle hill at the center portion in the direction along the inclination, and includes a flapper 950 in the vicinity of the top of the hill. A depression is formed above the flapper 950 along the inclination. A lower end of the fore arm 908 engages the depression, and the fore arm 908 extends in the directions substantially orthogonal to the loading plane of the base plate 915.

The booklets to be loaded on the base plate 915 slide down along the bed 903 and the loading plane of the base plate 915 by their own weights, and the fore arm 908 receives the leading ends of the booklets.

The side wall 902 on the lower side of the discharging port 901 includes a slot 81 formed therein. When the discharging roller pair 39a and 39b pushes the booklet and discharges the same from the discharging port 901, the projecting member 80 projects substantially horizontally from the slot 81.

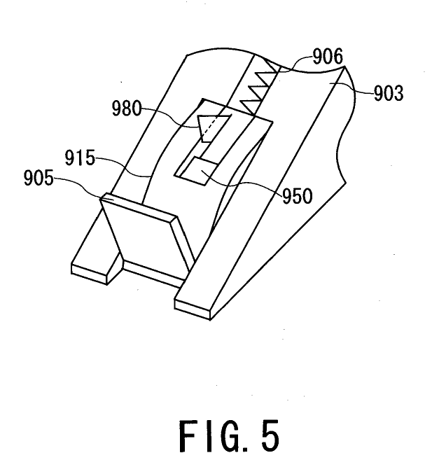

FIG. 5 is a drawing showing the sheet placing unit 40 with the upper arm 907 and the fore arm 908 removed. The bed 903 accommodates a sheet sensor (not shown) that detects the booklet in the interior thereof, and the sheet sensor includes a detection lever 980. If the booklet is not placed on the base plate 915, the detection lever 980 projects and is exposed from the depression on the base plate 915, as shown in FIG. 5. The detection lever 980 is retracted by the weight of the booklet placed on the base plate 915 even with a single booklet. With the movement of the detection lever 980, the sheet sensor is capable of differentiating a state having no booklet placed on the base plate 915 (non-loaded state) and a state having at least one booklet loaded thereon (loaded state).

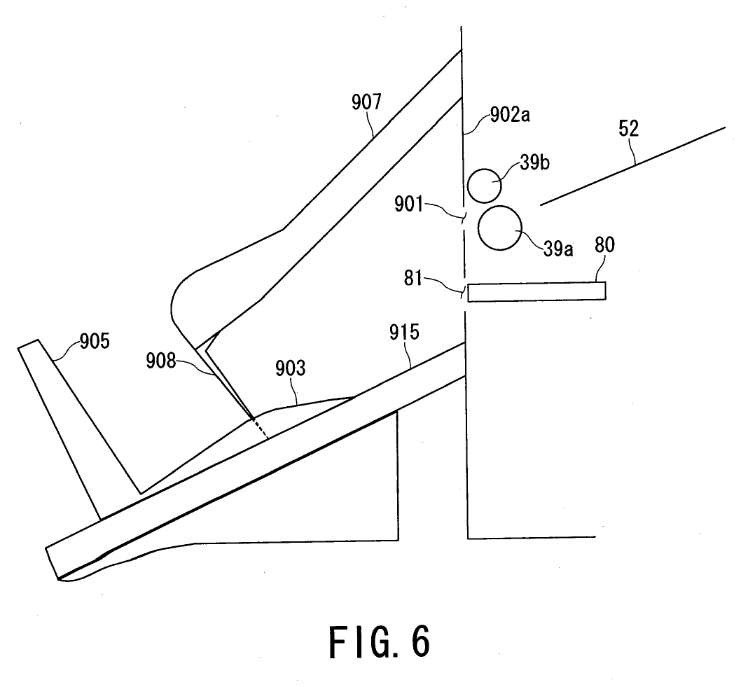

FIG. 6 is a diagrammatic drawing of the sheet placing unit 40 and part of the sheet finishing apparatus body (hereinafter, referred to simply as “main body”) viewed from the front (the direction where the operating unit 9 is located in FIG. 1). As described before, the sheet placing unit 40 includes the bed 903, the base plate 915, the upper arm 907, and the fore arm 908. The bed 903 and the base plate 915 extend obliquely downward from the side wall 902 of the main body to allow loading of the plurality of booklets discharged in sequence from the discharging port 901 provided in the side wall. The guard 905 is provided at a lower end of the base plate 915.

The discharging port 901 is provided in the side wall 902 of the main body, and the discharging roller pair 39a and 39b is provided inside thereof. The placing bed 52 is provided at the back of the discharging roller pair 39a and 39b. The booklet whose fold line is reinforced on the placing bed 52 is pushed by the discharging roller pair 39a and 39b and proceeds toward the sheet placing unit 40.

The sheet finishing apparatus 20 in this embodiment includes the plate-shaped or the rod-shaped projecting member 80 that projects from the side wall 902 substantially horizontally and supports the lower portion of the booklet between the discharging port 901 and the base plate 915 when the discharging roller pair 39a and 39b pushes the booklet out.

FIG. 6 shows a situation in which the projecting member 80 is at a home position. The home position of the projecting member 80 is a position in which the front end of the projecting member 80 aligns with, or comes inside the position of the side wall 902 in the direction of movement of the projecting member 80.

When the leading end of the booklet starts to be discharged from the discharging port 901, the projecting member 80 also starts to project horizontally from the slot 81, and proceeds toward the bed 903 while supporting the lower portion of the booklet.

The projecting member 80 moves in the direction opposite from the projecting direction toward the side wall 902 when the front end reaches a predetermined extending distance from the side wall 902. In contrast, the discharging roller pair 39a and 39b continues to push the booklet even after the projecting member 80 starts moving toward the side wall 902, drops the booklet from the projecting member 80, and loads the same on the bed 903 or the base plate 915. If focusing only on the function to load the booklets, the bed 903 and the base plate 915 have almost the same functions. Therefore, the description is given below on condition that the bed 903 is included in the base plate 915.

In the sheet finishing apparatus 20 in this embodiment, with the provision of the projecting member 80, smooth discharge of the booklets to the sheet placing unit 40 as well as stable and well-conditioned loading are achieved.

### (2) Operation of Projecting Member

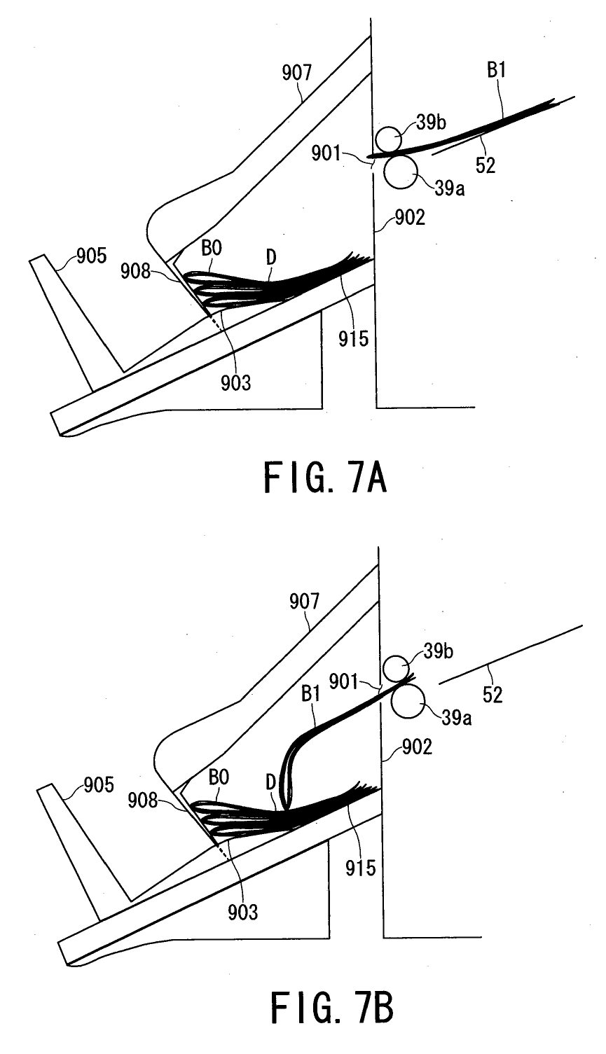

FIGS. 7A and 7B are diagrammatic drawings showing a situation in which the booklets are discharged and loaded by the sheet finishing apparatus in the related art, which does not have the projecting member 80, as a comparative example with respect to the sheet finishing apparatus 20 in this embodiment.

As mentioned above, booklets B0 loaded on the base plate 915 do not necessarily have a uniform thickness. Although it depends on the type or the number of sheets which constitute each booklet, they tend to be thicker at the leading end portions (portions in the vicinity of the fold lines) of the booklet. Therefore, when the number of the booklets B0 to be loaded is increased, a depression D may be formed in the vicinity of the center of the booklets B0. In FIG. 7A (also drawings from FIG. 7B onward), the illustration of the depression D is exaggerated for easy understanding of this phenomenon.

On the other hand, in general, while the booklet is hard to bend in the direction of the fold line, it is relatively easy to bend in the direction orthogonal to the fold line. Therefore, the booklet B1 discharged from the discharging port 901 tends to bend downward as shown in FIG. 7B. The leading end of the bent booklet B1 comes into abutment with the surface of the previously loaded booklet B0.

In particular, if the leading end of the booklet B1 comes into abutment with the previously loaded booklets B0 substantially at a right angle as shown in FIG. 7B, the surface of the previously loaded booklet B0 pushes back strongly the leading end of the booklet B1. Particularly, if the leading end of the booklet B1 comes into abutment with the depression D of the booklets B0, the pushing-back force of the surface of the booklets B0 further increases.

Therefore, even if the rear portion of the booklet B1 is pushed by the discharging roller pair 39a and 39b, the leading end of the booklet B1 cannot move further forward, and then the booklet B1 is placed on the base plate 915 in a bent state or in a displaced state. In addition, since the leading end of the booklet B1 is strongly pushed back, the discharging roller pair 39a and 39b may stop in the course of discharge of the booklet B1. If the discharging roller pair 39a and 39b stops, the subsequent booklet cannot be discharged to the sheet placing unit 40, so that a paper jamming occurs in the interior of the main body of the sheet finishing apparatus 20.

By contrast, in the sheet finishing apparatus 20 in this embodiment, such event is avoided by adding a relatively simple configuration such as the projecting member 80.

A method may be conceivable, which enhances the drive force of the discharging roller pair 39a and 39b and pushes the leading end of the booklet B1 forcedly toward the front against the depression D. However, since the discharging roller pair 39a and 39b is provided in the proximity of the inside of the discharging port 901, if the drive force of the discharging roller pair 39a and 39b is increased too much, it might cause a serious damage to a human body or the like when the human body such as a finger or a clothe is accidentally drawn therein. Therefore, the method of enhancing the drive force of the discharging roller pair 39a and 39b is not necessarily a preferable solving method.

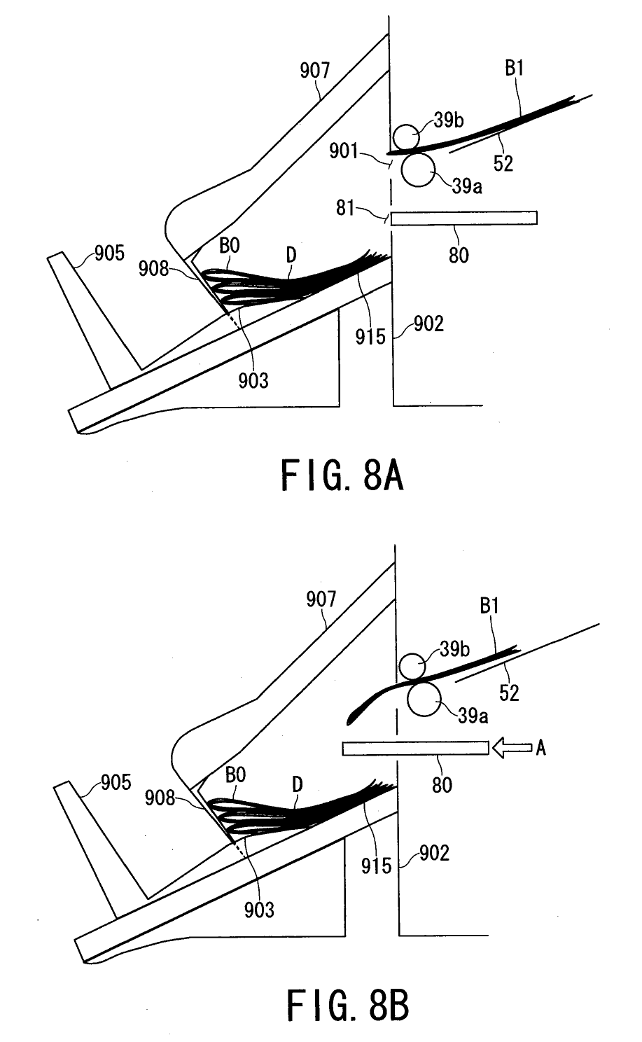

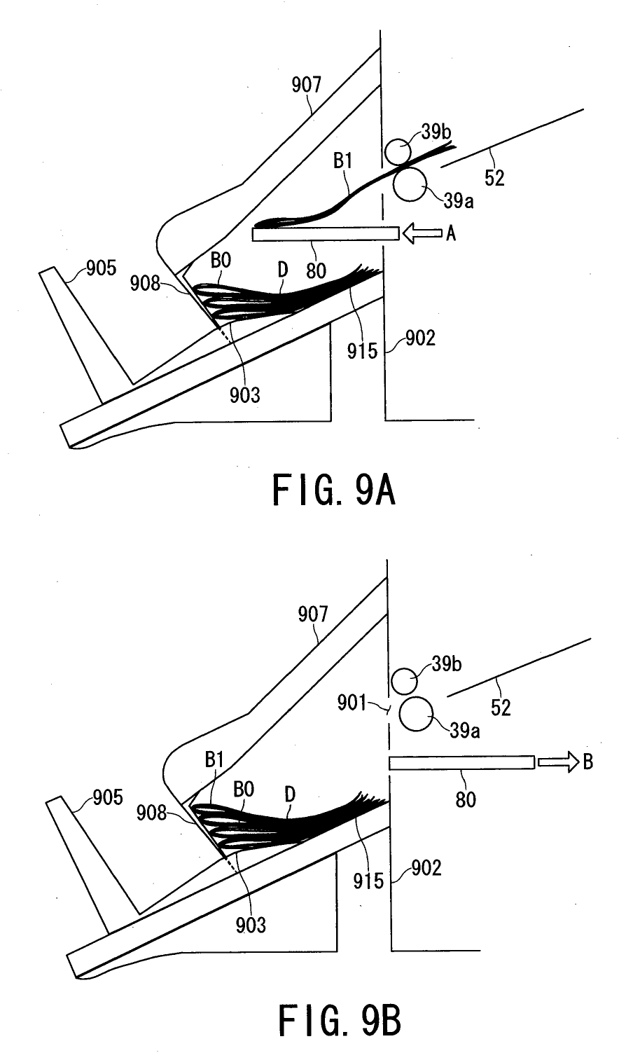

FIGS. 8A and 8B and FIGS. 9A and 9B are explanatory drawings showing effects of the projecting member 80.

FIG. 8A shows a situation in which the projecting member 80 is at the above-described home position. When the leading end of the booklet B1 which is about to be discharged is still inside the discharging port 901, the projecting member 80 is located at the home position. At this time, several booklets B0 are assumed to be placed already on the base plate 915.

FIG. 8B is a drawing showing a situation in which the leading end of the booklet B1 starts to be discharged from the discharging port 901. When the leading end of the booklet B1 starts to be discharged from the discharging port 901, the projecting member 80 starts moving forward (the direction toward the fore arm 908 indicated by an arrow A in FIG. 8B) substantially simultaneously thereto. The projecting member 80 moves substantially horizontally.

FIG. 9A is a drawing showing a situation in which the booklet B1 is pushed further forward. At this time, the projecting member 80 still continues to move forward. With this movement of the projecting member 80, even though the leading end portion of the booklet B1 hangs over by its own weight, the projecting member 80 is capable of letting the booklet B1 move forward while supporting the lower portion of the booklet B1.

By setting the discharging velocity of the booklet B1 and the moving velocity of the projecting member 80 toward the front to be substantially the same, the booklet B1 can be moved forward further stably without causing slippage between the lower portion of the booklet B1 and the projecting member 80.

When the projecting member 80 reaches a predetermined extending distance Dmax, the projecting member 80 changes the direction of movement and starts moving toward the home position. When the projecting member 80 starts moving toward the home position, the booklet B1 falls down from the leading end thereof toward the booklets B0 which are already loaded.

The extending distance Dmax is preferably a distance at which the position of the leading end of the booklet B1 gets beyond a position of half the length of the loaded booklets B0 in the discharging direction. In addition, the extending distance Dmax is preferably a distance at which the position of the leading end of the booklet B1 extends beyond the position of the front end of the depression D of the loaded booklets B0. It is because if the extending distance Dmax is a distance getting beyond a position of half the length of the booklets B0, or a distance getting beyond the position of the front end of the depression D, the position of the leading end of the booklet B1 which is falling down due to the backward movement of the projecting member 80 comes to a position beyond the deepest position of the depression D, and hence the pushing-back force that the leading end of the booklet B1 receives from the booklets B0 is alleviated.

FIG. 9B is a drawing showing a situation in which the projecting member 80 returns to the home position. When the trailing end of the booklet B1 is discharged from the discharging port 901, the projecting member 80 is preferably back to the home position. As described above, the front end of the projecting member 80 at the home position aligns with, or comes inside the position of the side wall 902. Therefore, the trailing end of the booklet B1 discharged from the discharging port 901 falls down without being hindered by the projecting member 80 and is loaded without displacement.

The projecting member 80 is a plate-shaped member, that is, a blade. The blade is formed so that the longitudinal direction thereof is horizontal along the side wall 902 and the short side direction is a moving direction of the blade, as shown in FIG. 4. However, the invention is not limited to this shape.

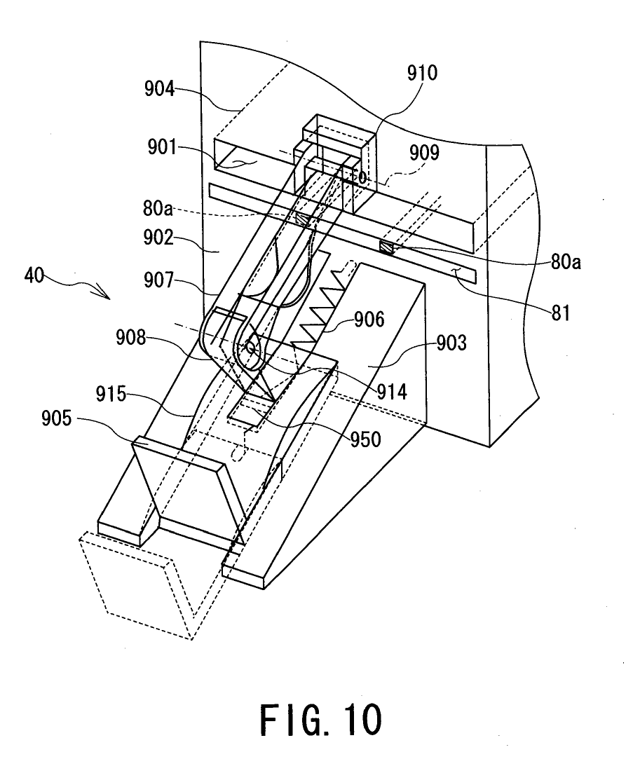

For example, the projecting member 80a may be formed of a rod-shaped member moving in the longitudinal direction thereof as shown in FIG. 10. The rod-shaped projecting member 80a may be of a rectangular column shape as shown in FIG. 10 or a circular column shape, and the cross-sectional shape is not specifically limited. Also, the number of the rod-shaped projecting members 80a is not limited specifically, as long as it can support the booklet B1 stably. As shown in FIG. 10, two or more of the rod-shaped projecting members 80a may be employed. Since the booklet B1 is generally hard to bend in the direction of the fold line, a configuration to support the center of the booklet B1 using a single rod-shaped member may also be applicable.

A drive mechanism for the projecting member 80, 80a is not described in detail. Known drive mechanisms can be used.

As described thus far, with the sheet finishing apparatus 20 and a sheet finishing method (booklet discharging method) according to the embodiment, even though the thickness of the bundle of booklets to be loaded on the sheet placing unit is not uniform, the smooth discharge of the subsequent booklet is achieved only by adding the simple projecting member 80, 80a to the configuration in the related art.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finishing apparatus comprising:
a main body configured to fold a bundle of sheets to form a booklet;
a base plate extending obliquely downward from a side wall of the main body to allow loading of a plurality of the booklets discharged in sequence from a discharging port provided in the side wall;
a discharging roller pair configured to push the booklet out from the discharging port to discharge the booklet on the base plate; and
a projecting member configured to project from the side wall substantially horizontally and support the lower portion of the booklet between the discharging port and the base plate when the discharging roller pair pushes the booklet out.

2. The apparatus according to claim 1, wherein the projecting member moves in the direction opposite from the projecting direction toward the side wall when the front end reaches a predetermined extending distance from the side wall, and
the discharging roller pair continues to push the booklet out even after the projecting member starts movement toward the side wall, drops the booklet from the projecting member and loads the same on the base plate.

3. The apparatus according to claim 1, wherein a home position of the projecting member is a position in which the front end of the projecting member aligns with, or comes inside the position of the side wall in the direction of movement of the projecting member.

4. The apparatus according to claim 3, wherein the projecting member is returned to the home position when the discharging roller pair discharges a trailing end of the booklet.

5. The apparatus according to claim 1, wherein the extending distance of the projecting member is a distance at which the position of the leading end of the booklet discharged from the discharging port gets beyond a position of half the length of the loaded booklet on the base plate in the discharging direction.

6. The apparatus according to claim 1, wherein a depression having a predetermined width in the discharging direction is formed at a center portion of the booklet loaded on the base plate, and
the extending distance of the projecting member is a distance at which the position of the leading end of the booklet discharged from the discharging port gets beyond a position of the front end of the depression.

7. The apparatus according to claim 1, wherein the projecting member is a blade formed so that the longitudinal direction thereof is horizontal along the side wall and the short side direction thereof is a moving direction of the blade.

8. The apparatus according to claim 1, wherein the projecting member is a rod-shaped member moving in the longitudinal direction thereof.

9. The apparatus according to claim 8, wherein the projecting member is formed of one or more rod-shaped members.

10. A sheet finishing method comprising:
folding a bundle of sheets and forming a booklet by a main body;
pushing the booklet out from a discharging port provided in a side wall of the main body by a discharging roller pair and discharging the booklet on the base plate;
loading a plurality of the booklets discharged in sequence from the discharging port on the base plate extending obliquely downward from the side wall of the main body; and
supporting the lower portion of the booklet by a projecting member projecting from the side wall substantially horizontally between the discharging port and the base plate when the discharging roller pair pushes the booklet out.

11. The method according to claim 10, wherein the projecting member moves in the direction opposite from the projecting direction toward the side wall when the front end reaches a predetermined extending distance from the side wall, and
the discharging roller pair continues to push the booklet out even after the projecting member starts movement toward the side wall, drops the booklet from the projecting member, and loads the same on the base plate.

12. The method according to claim 10, wherein a home position of the projecting member is a position in which the front end of the projecting member aligns with, or comes inside the position of the side wall in the direction of movement of the projecting member.

13. The method according to claim 12, wherein the projecting member is returned to the home position when the discharging roller pair discharges a trailing end of the booklet.

14. The method according to claim 10, wherein the extending distance of the projecting member is a distance at which the position of a leading end of the booklet discharged from the discharging port gets beyond a position of half the length of the booklet loaded on the base plate in the discharging direction.

15. The method according to claim 10, wherein a depression having a predetermined length in the discharging direction is formed at the center portion of the booklet loaded on the base plate, and
the extending distance of the projecting member is a distance at which the position of the leading end of the booklet discharged from the discharging port gets beyond a position of the front end of the depression.

16. The method according to claim 10, wherein the projecting member is a blade formed so that the longitudinal direction thereof is horizontal along the side wall and the short side direction thereof is a moving direction of the blade.

17. The method according to claim 10, wherein the projecting member is a rod-shaped member moving in the longitudinal direction thereof.

18. The method according to claim 17, wherein the projecting member is formed of one or more rod-shaped members.
